(19) United States
(12) Patent Application Publication
(10) Pub. No.: US 2015/0169052 A1
(43) Pub. Date: Jun. 18, 2015

(54) MEDICAL TECHNOLOGY CONTROLLER

(71) Applicant: Siemens Aktiengesellschaft, Munich (DE)

(72) Inventor: Gerhard KRÄMER, Igensdorf (DE)

(21) Appl. No.: 14/566,772

(22) Filed: Dec. 11, 2014

(30) Foreign Application Priority Data
Dec. 17, 2013 (DE) 102013226244.2

(51) Int. Cl. G06F 3/01

(52) U.S. Cl. CPC G06F 3/013

(57) ABSTRACT

A method is disclosed for controlling a medical technology imaging device and/or an information display device, which, by way of a user input, displays data generated with the medical technology imaging device to a user. In an embodiment, the user input is performed at least on the basis of an eye-tracking and/or eye-motion detection in combination with a further non-contact user input recognition logic. An embodiment of the invention further relates to a correspondingly embodied controller system.

### PRIORITY STATEMENT

The present application hereby claims priority under 35 U.S.C. §119 to German patent application number DE 102013226244.2 filed Dec. 17, 2013, the entire contents of which are hereby incorporated herein by reference.

### FIELD

At least one embodiment of the present invention generally relates to a method for controlling a medical technology imaging device and/or an information display device which, by way of a user input, displays to a user data generated with the medical technology imaging device. It also generally relates to a controller system for controlling a medical technology imaging device and/or an information display device which displays to a user data generated with the medical technology imaging device.

### BACKGROUND

Medical technology imaging devices, such as computed tomographs (CT), ultrasound devices, magnetic resonance tomographs (MR), x-ray apparatus, angiographs, single proton emission computed tomographs (SPECT) and positron emission tomographs (PET) and many more, have previously usually been controlled by way of touch-based control, i.e. via an input at a keyboard, touch surface, mouse or joystick.

To perform such control a user, i.e. a radiologist or radiology specialist, must generally leave the room in which the medical technology imaging device concerned is located or at least turn away from the examination object (i.e. mostly a human patient) and then make his input while turned away.

### SUMMARY

At least one embodiment of the present invention provides an alternate control option for medical technology imaging devices or for the information display devices which especially are preferably easier or less complicated or more convenient for the user (and/or the examination object) to operate.

A method and a controller system are disclosed.

In accordance with at least one embodiment of the invention, for a method, the user input is performed at least on the basis of an eye position and/or motion detection in combination with a further non-contact recognition logic.

At least one embodiment of the invention thus primarily makes use of what is known as eye tracking, a technology in which the eye position (i.e. the direction of view and/or the focusing of a human eye) and/or the motion of the eye is detected. This technology is currently used for attention research in advertising and likewise for communication with very severely disabled people. The fixing of points (fixation) in the room is a voluntarily controllable process, whereas eye motions (saccades) are ballistic and thus straight line and as a rule not completely voluntarily controllable. (cf. Khazaeli, C. D.: Systemisches Design (Systemic Design). Hamburg 2005. P. 68, the entire contents of which are hereby incorporated herein by reference). Both the fixing of points and also the eye motion can currently be determined with the aid of eye tracking and both information components can be used for recognizing a user input. The first, for example as a reproduction of voluntary processes, the latter for example for verification of such a statement of intent by examining such subliminal reactions. Eye-tracking devices for computers are offered by Tobii of Danderyd, Sweden for example. Other eye-tracking algorithms are however principally also able to be used.

In accordance with at least one embodiment of the invention, a controller system comprises a control command generation unit for generation of control commands from a user input, which control command generation unit is realized so that in operation it carries out the user input at least on the basis of an eye position or eye motion detection in combination with a further non-contact user input recognition logic.

At least one embodiment of the invention therefore also comprises a computer program product which is able to be loaded directly into a processor of a programmable controller system, with program code segments for executing all steps of at least one embodiment of the inventive method when the program product is executed on the controller system.

### BRIEF DESCRIPTION OF THE DRAWINGS

The invention will be explained once again in greater detail below, referring to the enclosed figures, on the basis of example embodiments. In the explanations, the same components are provided with identical reference characters. In the figures:

FIG. 1 shows a perspective view of an example embodiment of an inventive imaging device,

FIG. 2 shows a detailed view from FIG. 1,

FIG. 3 shows a schematic block diagram of the same imaging device with an example embodiment of an inventive controller system,

FIG. 4 shows a schematic block flow diagram of an example embodiment of the inventive method.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the invention thus primarily makes use of what is known as eye tracking, a technology in which the eye position (i.e. the direction of view and/or the focusing of a human eye) and/or the motion of the eye is detected. This technology is currently used for attention research in advertising and likewise for communication with very severely disabled people. The fixing of points (fixation) in the room is a voluntarily controllable process, whereas eye motions (saccades) are ballistic and thus straight line and as a rule not completely voluntarily controllable. (cf. Khazaeli, C. D.: Systemisches Design (Systemic Design). Hamburg 2005. P. 68, the entire contents of which are hereby incorporated herein by reference). Both the fixing of points and also the eye motion can currently be determined with the aid of eye tracking and both information components can be used for recognizing a user input. The first for example as a reproduction of voluntary processes, the latter for example for verification of such a statement of intent by examining such subliminal reactions. Eye-tracking devices for computers are offered by Tobii of Danderyd, Sweden for example. Other eye-tracking algorithms are however principally also able to be used.

In addition to eye tracking, the user input is now combined with a further non-contact user input recognition logic. Examples of further non-contact user input systems are listed below. Common to all non-contact user input technologies is that a user does not have to be in physical contact or come into the immediate vicinity of input hardware, but instead a kind of remote interrogation of his user input is undertaken by sensor technology. In such cases the user can especially be located in different positions (mostly in practically any conceivable position in the room), i.e. he is not restricted to specific positioning during user input.

This combination of two non-contact user inputs into one combined user input has at least two effects: Firstly it offers the advantage of redundant systems. It is therefore preferred that user commands are only evaluated as such when both user inputs deliver a consistent overall result meaningful per se. Secondly different information from the two user inputs can relate to different circumstances, motions and declarations of intent which then, combined with one another, define the overall picture of the user input. Eye tracking for example offers the advantage that with its help a precise location of a point targeted by the user, on a display for example, is possible. Other non-contact user input recognition logic can then interrogate additional information about the targeted location, such as what is to be done with an object at the targeted location.

The method provided in this way is thus easy to manage, can be designed to be very precise and reliable and additionally offers the advantage of a high level of safety (i.e. low susceptibility to errors) during user input.

In accordance with at least one embodiment of the invention, a controller system comprises a control command generation unit for generation of control commands from a user input, which control command generation unit is realized so that in operation it carries out the user input at least on the basis of an eye position or eye motion detection in combination with a further non-contact user input recognition logic.

At least one embodiment of the inventive controller system is thus embodied for carrying out at least one embodiment of the inventive method. It can be realized as a stand-alone unit or as part of the medical technology imaging device. Therefore at least one embodiment of the invention also relates to a medical technology imaging device with an imaging unit and at least one embodiment of an inventive controller system.

Overall a large part of the components for realizing the controller system in the inventive manner, especially the control command generation unit, can be realized entirely or in part in the form of software modules on a processor. A number of the units can also be combined into a common functional unit.

Interfaces of the controller system do not absolutely have to be embodied as hardware components, but can also be realized as software modules, for example if the data can be taken from other components already realized on the same device, such as an image reconstruction facility or the like for example, or just has to be transferred by software to another component. Likewise the interfaces can include hardware and software components, such as a standard hardware interface for example which is specifically configured by software for the actual intended purpose. In addition a number of interfaces can also be combined in one common interface, for example an input/output interface.

At least one embodiment of the invention therefore also comprises a computer program product which is able to be loaded directly into a processor of a programmable controller system, with program code segments for executing all steps of at least one embodiment of the inventive method when the program product is executed on the controller system.

Further especially advantageous embodiments and developments of the invention emerge from the dependent claims as well as the description given below. In such cases the controller system can also be developed in accordance with the respective dependent claims for the method or vice versa.

In accordance with a first variant of at least one embodiment of the invention, the further non-contact user input recognition logic comprises motion detection of extremities of the user. The extremities include in particular the limbs, especially the arms and hands (or parts hereof, specifically the fingers) and the head of the user. Such motion detection is also referred to by the term motion tracking. Devices for motion tracking of finger motions are marketed for example under the name “Leap Motion Controller” by Leap Motion of San Francisco, USA. Other motion recognition algorithms are however principally also able to be used within the framework of at least one embodiment of the invention.

The combination of the eye tracking described above with motion tracking to form a type of “combined gesture” is especially preferred in that declaration of intent signals can be recognized particularly well with motion tracking. Such a simple, intuitive declaration of intent signal is nodding or shaking the head, but also finger motions are not only simply able to be recognized by a motion tracking system but are also able to be learned intuitively for a user. Thus this combination offers an especially high level of safety during control.

A second variant, which can be employed as an alternative to or in addition to the first variant (and also in combination with other non-contact user input recognition logics not described in any greater detail), includes the further non-contact user input recognition logic including a recognition of acoustic signals, especially voice signals, of the user. Acoustic signals can comprise noises or sounds for example, as we use for example in everyday usage of speech—such as sounds for indicating yes (“mhh”) or no (“ä-äh”), especially however they comprise voice signals which can be made recognizable as user inputs with the aid of speech recognition algorithms. For example Nuance from Burlington, USA offers speech recognition software under the name Dragon Naturally Speaking which can be used within this framework. Other speech recognition algorithms are principally however also able to be used within the framework of at least one embodiment of the invention.

Each of the variants has its specific advantages. Speech recognition offers the advantage that a user does not have to separately learn a “vocabulary” of eye motions in order to perform user inputs, but that they can control the system completely intuitively based on their speech or noises that they make: Instead the speech recognition algorithm learns the vocabulary of the user. On the other hand eye motion recognition has the advantage of patients not being irritated during control of the imaging (or image reproduction) by speech information of the user (i.e. of the person performing the treatment) or even feeling that they are being spoken to themselves.

It is further especially preferred that the user input takes place in the same room in which the medical technology tomography device and/or the image information display device is located. This means that the user makes his user inputs where the tomography device is operating. This makes a direct interaction between the user and the device concerned possible (including a rapid overview of the effects of the user control). Moving from this room into another room for the purposes of user control is thus not necessary and is also not desirable, except for safety purposes, especially radiation protection.

In addition, it is an especially preferred application of at least one embodiment of the inventive method to carry out the method during an interventional procedure in an examination object. This interventional procedure is supported within this context by images acquired by the medical technology imaging device. In this specific application the advantages of at least one embodiment of the invention are shown to particularly good advantage since, with such image-assisted intervention, the immediate proximity of the person performing the treatment to the examination object, i.e. the patient, is especially desirable: An operator or person performing the treatment plans his intervention on the basis of the images acquired by the imaging device, such as a path of a needle for an infusion or intervention needle. In such cases he can draw in the desired position of the needle (or of another intervention instrument) as well as its desired path in the tissue in the previously acquired images. In such situations he is wearing sterile gloves so that controlling the imaging device or the information display device connected to the imaging device in the given circumstances of control by means of touch signals is especially complicated and time-consuming. Previously the person performing the treatment namely had to leave the operation room to make sure of the needle position in the tissue or he had to use a type of joystick control or some other type of touch interface of a monitor located in the operation room. This in its turn meant that the joystick or the touch interface also had to be kept strictly sterile, for example with the aid of sterile wipes. This in its turn restricted the simple operability of the operating elements because they naturally no longer reacted so well.

When at least one embodiment of the inventive method is used as part of such an interventional procedure on the other hand, both the intervention planning and also the acquisition of further images by the imaging device are much simpler, since the process is non-contact and yet reliable.

A few especially preferred applications of the controller with the aid of the inventive method are explained in greater detail below. This is not to be considered as restrictive but however shows especially striking advantageous applications of the invention and explains by way of example the interaction of purpose, type and form of the user input.

A first, especially preferable example embodiment relates to an inventive method in which the user input comprises an enabling input for enabling an execution of imaging by the medical technology imaging device. As part of an image-supported interventional procedure this means that both the initial image acquisition for generation of a first image (for the purposes of intervention planning) and also (and especially) further image acquisitions during the intervention can be carried out with the aid of at least one embodiment of the inventive method. In such further image acquisition during the intervention the person performing the treatment can thus, while a needle is applied in the body of the examination object for example, check the position of the needle by initiating a further image acquisition. Looking at a particular point for example on a monitor or on an imaging device can be recognized for example by eye tracking and/or motion detection, and a gesture—for example with the free hand, while the other hand continues to hold the needle—can be recognized by motion tracking. The recognition signals based on eye tracking and on motion tracking serve to control, i.e. for example initiate, the image acquisition.

A second example embodiment relates to an inventive method in which the user input comprises a selection input, wherein the user looks at an object and/or a region to be selected with his eye and initiates a selection of the viewed object by way of a declaration of intent signal. This example embodiment thus primarily relates to the display of an image on the information display device concerned. In such cases a selection can be created in a similar way to a mouse click. This mouse click can be represented by a corresponding finger gesture (such as a bending of a finger immediately followed by straightening of the finger or by a motion of the tip of a finger—especially of an index finger) while the position or focusing of the eye indicates where the “click” is to be made. Examples of using such simulated mouse clicks are for example the choice an interaction button on a monitor or the marking or selection of (image) elements on a monitor display.

As a development, the selection input can be continued by the user moving the selected object by way of a movement signal to a location at which he is looking after the initiation of the selection. This development thus comprises a type of “drag” gesture: By looking at an element (for example a slider control) on an information display device, such as a monitor for example, and a selection gesture such as the one described above for example, the drag can be performed: a subsequent movement of the hand and/or of the eye upwards or downwards or in any given sideways direction, i.e. relatively away from the initial position of the element, can be used as a signal for moving the element, i.e. the selected object. Such drag gestures can be used in general both for the selection and movement of control elements and also for carrying out (area) markings.

As a further development, the movement thus effected can be ended by a movement confirmation signal of the user, i.e. confirmed. This means that the movement process comprises a type of “drag and drop” function. In such cases the effect of the movement confirmation signal is to complete the move, i.e. it fulfills the “drop” function in the drag-and-drop process so to speak.

A third example embodiment relates to an inventive method in which the user input comprises a graphical input of an object. In particular the graphical input can be drawing objects such as straight lines and/or curved lines, closed and/or open shapes and much more besides within an image, which image is displayed on the information display device. The example of drawing a needle path for intervention planning has already been explained above. Such a “drawing” function in the user input can be understood or implemented similarly to the drag-and-drop function explained above. In this case a gesture recognized by motion tracking—of a finger for example—can be detected as the initiation of the drawing process and a subsequent motion of the finger, of the hand or of the eye can define the spatial extent of the object input. A further gesture—of the same finger again for example (and/or of another finger or of another extremity)—can bring the drawing process to a conclusion.

A fourth example embodiment relates to an inventive method in which the user input comprises a forwards and/or backwards motion and/or an upwards and/or downwards motion and/or scrolling within the displayed data. This type of user input thus comprises a type of navigation within the data, for example images which are displayed by the information display device. Thus for example by an upwards or downwards motion of a (for example flat) hand, scrolling can be undertaken in the image acquisition layers or the scrolling in DICOM layers can be carried out with the aid of eye tracking.

A fifth example embodiment relates to an inventive method in which the user input comprises a confirmation signal which enables user inputs previously made and/or comprises a cancelation signal which cancels user inputs previously made especially at a time before a confirmation signal. This type of user input is to be seen as similar to pressing an “Enter” key or a “Delete” key on the computer. It serves generally to initiate a safety signal, i.e. either the final confirmation of a user input or a cancelation of a user input. It is thus insured that an incorrect input is not made by the user without the user actually wishing to do this.

In addition, it is possible in this way to correctly time the control commands generated by the user input. As part of at least one embodiment of the invention, which can (at least potentially) be based exclusively on non-contact user entries, such a final user confirmation entry or the provision of a cancel function before the implementation of the control commands has the advantage of increased process safety and above all increasing the trust of the user in the system. This thus enables the acceptance of the user for the innovative non-contact control to be increased.

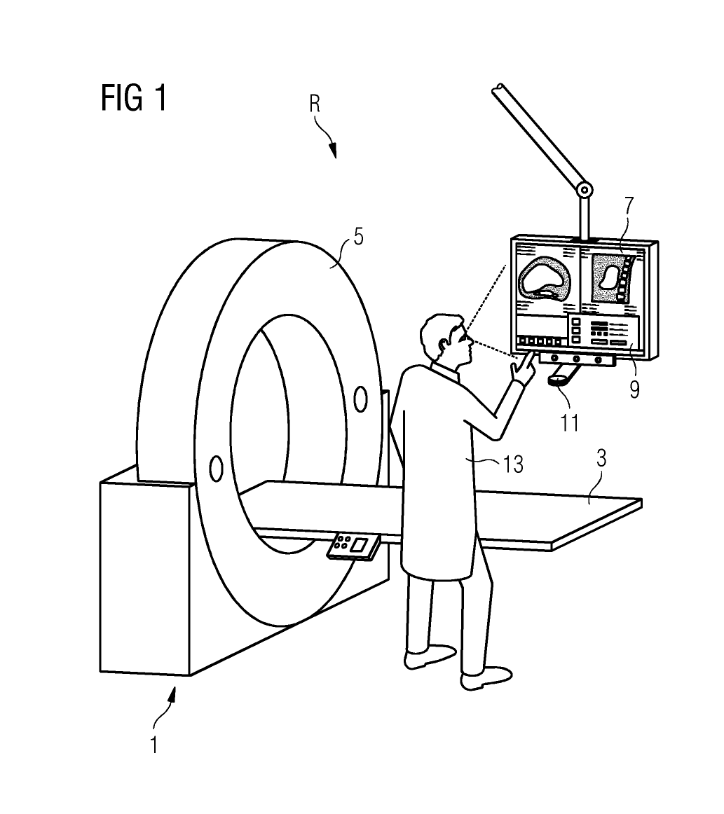

FIG. 1 shows an embodiment of an inventive imaging device 1, here a magnetic resonance tomograph 1 with an imaging unit 5 into which an examination object (not shown) can be moved on a patient table 3. The imaging device 1 includes an information display device 7 in the form of a monitor 7, at which a user 13, here a doctor 13 performing the treatment, is presented with image data from an image acquisition by the imaging unit 5. Two non-contact input systems 9, 11 are also integrated into the area of the monitor 7, namely an eye-tracking system 9 and a motion-tracking system 11. For non-contact user input the doctor 13 makes use of these two input systems 9, 11, and to do so is located in the same room R as the imaging device 1. For example, in this way, even during an interventional procedure supported by image data from the imaging device 1 displayed on the monitor 7, he can retain direct access to all images and control both of the imaging unit 5 and also of the display of the monitor 7.

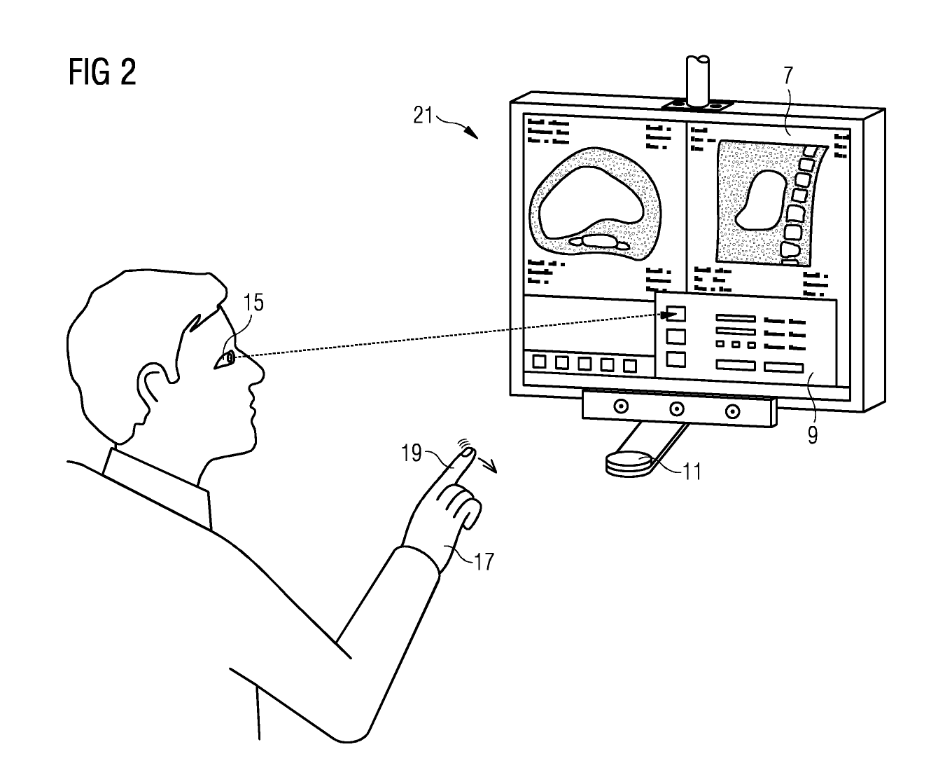

The user input is explained in greater detail by way of example in FIG. 2. The imaging device 1 includes a controller system 21 for controlling the imaging device 1 or the monitor 7. Slice images from an image acquisition by the imaging unit 5 are currently being displayed here on the monitor. In order to be able to navigate in the image data and to modify or supplement said data if necessary—for example by drawing-in a desired needle path for an interventional procedure, a combined user input is carried out via the eye-tracking system 9 and the motion-tracking system 11. The eye-tracking system 9 detects positions and/or motion of an eye 15 of the doctor. The motion tracking system 11 here detects motion of a finger 19 or of a hand 17 of the doctor 13. Control commands are derived from the combination of the two motion detections (eye 15 and finger 19 or eye 15 and hand 17), which here control the image display of the monitor 7. In the same way for example a further image acquisition can also be initiated by the recording unit 5.

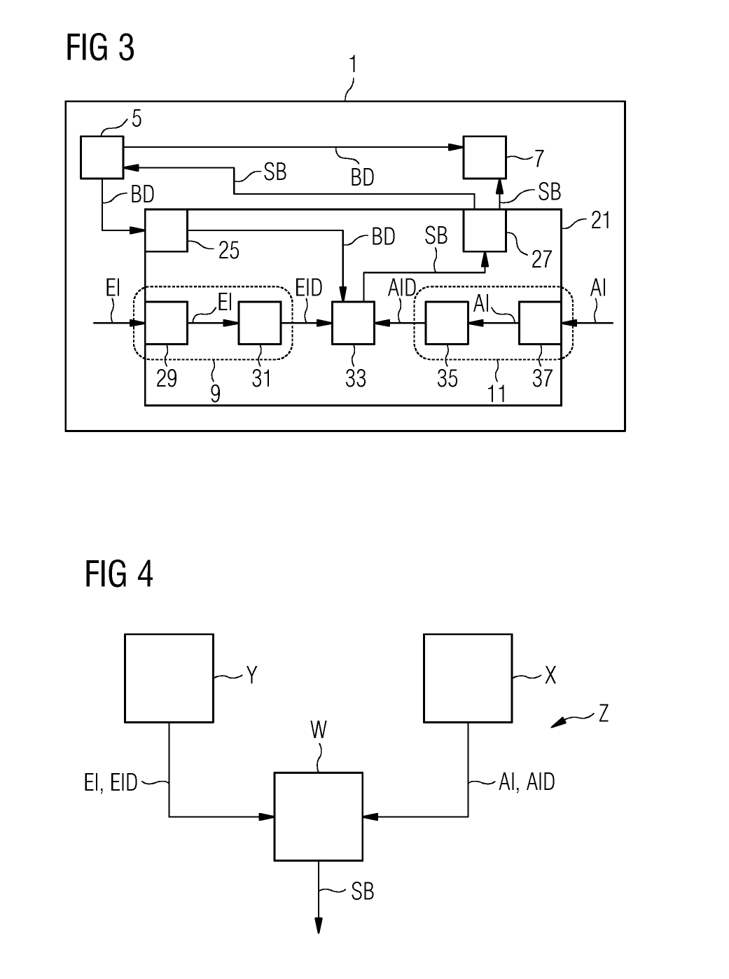

FIG. 3 shows the imaging device 1 schematically in a block diagram. Once again, it includes the imaging unit 5 and the monitor 7 (wherein a similar information display device can also be realized as a unit separate from the imaging device 1) and the controller system 21.

The controller system 21 includes an input interface 25 and an output interface 27. It also includes an eye-tracking system 9 and a second non-contact input system 11, which here, as mentioned above, is realized as a motion-tracking system 11, but which can also include acoustic signal recognition instead of motion recognition. The controller system also includes a control command generation unit 33.

The eye-tracking system 9 comprises a number of input sensors 29 and a first evaluation unit 31; similarly the second non-contact input system 11 comprises a number of input sensors 37 and a second evaluation unit 35. The input sensors 37 of the second non-contact input system 11, realized here as a motion-tracking system 11, are embodied as optical sensors 37; for an acoustic signal recognition system they would comprise acoustic sensors for example (for example a number of microphones).

During an image acquisition the imaging unit 5 generates data BD, especially image data BD of an examination object. This is transferred to the controller system 21 via the input interface 25 and is forwarded there to the control command generation unit 33.

First user inputs EI in the form of eye movements and/or eye positions EI are picked up by the number of input sensors 29 and recognized in the first evaluation unit 31. This results in the eye-recognition data EID, which is fed into the control command generation unit 33. Similarly second user inputs AI—here i.e. movements AI of one or more extremities, namely of the finger 19 or of the hand 17—are picked up via the input sensors 37 and recognized in the second evaluation unit 35, from which second recognition data AID, here i.e. motion-recognition data AID, results, which is likewise fed into the control command generation unit 33. From said data the control command generation unit 33 derives a combined user input and generates, on the basis thereof, a number of control commands SB, which are forwarded via the output interface 27 to the imaging unit 5 and/or to the monitor 7 (depending on type of control commands SB) and control the imaging unit 5 and/or the monitor 7.

FIG. 4 shows the steps of an example embodiment of the inventive method Z for controlling a medical technology imaging device 1 and/or an information display device 7 as a block diagram which refers to FIG. 3. In this diagram, in a first step Y, an eye position and/or motion detection (Y) is performed, from which the first user inputs EI are detected or the eye-recognition data EID based thereon is generated. In a second step X (parallel or lying beforehand or afterwards in time), in a similar way the second user inputs AI are detected or the motion-recognition data AID based thereon is generated. In a third step W, which follows on in time from the two steps Y, X or is executed at the same time as said steps, the control commands SB are generated on the basis of the first and second user inputs EI, AI.

Finally it is pointed out once again that embodiments of the method described in detail above, as well is the facilities presented, merely involve example embodiments which can be modified by the person skilled in the art in a wide diversity of ways, without departing from the scope of the invention. Furthermore the use of the indefinite article “a” or “an” does not exclude the features involved also being able to be present a number of times.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for controlling at least one of a medical technology imaging device and an information display device, which, via a user input, is configured to display data generated with the medical technology imaging device to a user, comprising:
performing the user input at least on the basis of at least one of an eye-tracking and eye-motion detection in combination with a further non-contact user input recognition logic.

2. The method of claim 1, wherein the further non-contact user input recognition logic comprises detecting movement of extremities of the user.

3. The method of claim 1, wherein the further non-contact user input recognition logic comprises detecting acoustic signals of the user.

4. The method of claim 1, wherein the user input is made in the same room in which the at least one of medical imaging device and the information display device is located.

5. The method of claim 1, wherein the method is performed during an interventional procedure in an examination object, the interventional procedure being supported by images acquired by the medical technology imaging device.

6. The method of claim 1, wherein the user input comprises an initiation input to initiate the carrying out of imaging by the medical technology imaging device.

7. The method of claim 1, wherein the user input includes a selection input, wherein the user looks at at least one of an object to be selected and a region to be selected with his eye and initiates a selection of the viewed object by way of a declaration of intent signal.

8. The method of claim 7, wherein the selection input is continued by the user moving the selected object by way of a movement signal to a location at which he is looking after initiating the selection.

9. The method of claim 8, wherein the movement is ended by a movement confirmation signal of the user.

10. The method of claim 1, wherein the user input comprises a graphical input of an object.

11. The method of claim 1, wherein the user input comprises at least one of a forwards and backwards motion, an upwards and downwards motion and a scrolling within the displayed data.

12. The method of claim 1, wherein the user input comprises at least one of a confirmation signal which enables user inputs previously made and a cancelation signal which cancels user inputs previously made.

13. A controller system for controlling at least one of a medical technology imaging device and an information display device, which displays data generated with the medical technology imaging device to a user, comprising:
a control command generation device to generate control commands from a user input, the control command generation device being realized to, in operation, perform the user input at least on the basis of at least one of an eye-tracking and eye-motion detection in combination with a further non-contact user input recognition logic.

14. A medical-technology imaging device comprising:
an imaging unit; and
the controller system of claim 13.

15. A computer program product, directly loadable into a processor of a programmable controller system, including program code segments for carrying out the method of claim 1 when the program product is executed on the controller system.

16. The method of claim 3, wherein the acoustic signals are voice signals of the user.

17. The method of claim 12, wherein the user input comprises at least one of a confirmation signal which enables user inputs previously made and a cancelation signal which cancels user inputs previously made, previously performed at a time before a confirmation signal.

18. A computer program product, directly loadable into a processor of a programmable controller system, including program code segments for carrying out the method of claim 2 when the program product is executed on the controller system.

19. The method of claim 2, wherein the further non-contact user input recognition logic comprises detecting acoustic signals of the user.

20. The method of claim 2, wherein the user input is made in the same room in which the at least one of medical imaging device and the information display device is located.
